(19) United States
(12) Patent Application Publication
(10) Pub. No.: US 2024/0188515 A1
(43) Pub. Date: Jun. 13, 2024

(54) METHOD FOR SPRAYING ROBINIA PSEUDOACACIA ON EXPOSED SHALE WALLS TO EFFICIENTLY AND RAPIDLY RESTORE GREEN AND IMPROVE SOIL PH VALUE

(71) Applicant: NANJING FORESTRY UNIVERSITY, Nanjing (CN)

(72) Inventors: JIAYAO ZHUANG, Nanjing (CN); CHAO LIU, Nanjing (CN); GUOHUA FAN, Nanjing (CN); KUN TIAN, Nanjing (CN); JINCHI ZHANG, Nanjing (CN)

(73) Assignee: NANJING FORESTRY UNIVERSITY, Nanjing (CN)

(21) Appl. No.: 17/180,730

(22) Filed: Sep. 12, 2023

Related U.S. Application Data
(63) Continuation of application No. PCT/CN2020/113417, filed on Sep. 4, 2020.

(30) Foreign Application Priority Data
Sep. 29, 2019 (CN) 2019109386467

(51) Int. Cl. A01G 24/60; C05F 5/00; C05F 11/10

(52) U.S. Cl. CPC A01G 24/60; C05F 5/008; C05F 11/10

(57) ABSTRACT

A method for spraying Robinia pseudoacacia on exposed shale wall to efficiently and rapidly restore green and improve soil pH value is provided. External-soil spray seeding is used to spray mixed microorganisms, organic fertilizer, and soil on exposed shale walls with a green plant of Robinia pseudoacacia to efficiently and rapidly restore green and improve soil pH value. The mixed microorganisms include Kocuria sp. X-22, Microbacterium sp. X-26, Bacillus sp. X-28 and Microbacterium sp. X-18, and the mixed microorganisms are added to organic fertilizer and soil by fermentation broth. The weight ratio of mixed microorganisms, organic fertilizer and soil is 1:1:8. The method can promote the rapid growth of Robinia pseudoacacia on the exposed shale wall and significantly increase organic matter content, effective phosphorus content, and pH value of the Robinia pseudoacacia soil.

### REFERENCE TO SEQUENCE LISTING

The substitute sequence listing is submitted as an ASCII formatted text filed via EFS-Web, with a file name of “Sequence_Listing_GLP_US_SJDL042.TXT”, a creation date of Dec. 29, 2022, and a size of 6606 bytes. The substitute sequence Listing filed via EFS-Web is a part of the specification and is incorporated in its entirety by reference herein.

### TECHNICAL FIELD

The present disclosure relates to the technical field of soil improvement, and more specifically, to a method for spraying Robinia pseudoacacia on exposed shale wall to efficiently and rapidly restore green and improve soil pH value.

### BACKGROUND

Soil is a basis of forestry production, an important carrier of nutrients in material circulation and energy flow, and one of the important factors affecting the environment. With the progress of human civilization, a series of activities such as mining and road construction have caused ecological problems such as the destruction of mountain vegetation, exposed rock walls, and increasing soil erosion. Artificial development and utilization of land will not only change the soil structure, but also change soil fertility and activity, which has a serious impact on the soil material cycle.

Acidity and alkalinity of soil is an important index for evaluating soil nutrients. It has an extremely important impact on the growth and development of animals and plants, the distribution of microbial population characteristics and their activities, and the existence of soil nutrients. Acidic soils are widespread worldwide, and soil acidification is mainly caused by factors such as excessive use of nitrogen fertilizer, a large number of plant harvests, and acid deposition.

As the pH value decreases, the positive charge H⁺ increases accordingly, resulting in a decrease in the adsorption of the nutrient segregants Ca2⁺, Mg2⁺, K⁺, etc. in the soil. At the same time, under acidic conditions, aluminum compounds that can be absorbed by plants are formed in the soil, which has some toxic effects on crops. In addition, soil acidification can also compact the upper soil and even cause the main surface to crust. Soil compaction will make the roots of crops difficult to breathe, so that the number of roots will be reduced, the shape will become shorter and thicker, and the roots will not be deep. This will prevent plants from getting sufficient water and nutrients. In addition, the compacted soil will accelerate the loss of soil moisture, and the drought tolerance of the soil will also decrease, which will not be conducive to the growth of plants.

In the prior art, the application of lime is usually used to neutralize the active and latent acids in the soil. However, studies have shown that no matter whether lime is applied or not, the soil has a reacidification effect, and the application of lime accelerates the reacidification effect of the soil. In addition, excessive application of lime can also cause problems such as soil compaction or nutrient loss.

The use of microorganisms to improve acidic soil is a green and economical improvement method that can improve the soil available fertility, promote plant growth, and reduce the amount of fertilizer applied.

With the rapid development of external-soil spray seeding, active soil bacteria are made into inoculant and bacterial fertilizer and added to the spraying substrate, interacting with the physical structure of the spraying substrate, plant roots and plant physiological and biochemical life activities, so that the vegetation growth effect of the sprayed soil is better. Therefore, to improve the physical and chemical properties of the soil, such as pH value, it becomes particularly important to screen suitable soil bacteria and their adapted plants to achieve symbiotic and mutual promotion effects.

### SUMMARY

In view of the shortcomings in the prior art, the technical problem to be solved by the present disclosure is to provide a method for spraying Robinia pseudoacacia on exposed shale wall to efficiently and rapidly restore green and improve soil pH value. It can significantly increase the pH value of acidic soil, improve the content of soil organic matter, and reduce the number of chemical fertilizers. It is a green, environmentally friendly, economical and affordable microbial improvement method. It can provide a low-cost and efficient new method for the efficient and rapid green restoration of rock walls.

In order to solve the above technical problems, the technical solutions adopted by the present disclosure are as follows.

A method for spraying Robinia pseudoacacia on exposed shale wall to efficiently and rapidly restore green and improve soil pH value is provided. External-soil spray seeding is used to spray a microbial mixed bacteria, an organic fertilizer, and a soil on slope protection soil of exposed shale walls with a spraying thickness of 8-10 cm and a green plant of Robinia pseudoacacia; a microbial mixed bacteria and a leguminous nitrogen-fixing bacteria are used synergistically to promote the rapid growth of Robinia pseudoacacia on exposed shale walls and take root in rock crevices; exposed rock walls are quickly re-greened and the soil pH is improved.

The microbial mixed bacteria include Kocuria sp. X-22, Microbacterium sp. X-26, Bacillus sp. X-28 and Microbacterium sp. X-18.

The Kocuria sp. X-22 is preserved in China Center for Type Culture Collection with a preservation date of Apr. 8, 2019, a preservation number of CCTCC No: M 2019237 and a preservation address of Wuhan University, Wuhan, China.

The Microbacterium sp. X-26 is preserved in China Center for Type Culture Collection with a preservation date of Apr. 8, 2019, a preservation number of CCTCC No: M 2019238 and a preservation address of Wuhan University, Wuhan, China.

The Bacillus sp. X-28 is preserved in China Center for Type Culture Collection with a preservation date of Apr. 8, 2019, a preservation number of CCTCC No: M 2019239 and a preservation address of Wuhan University, Wuhan, China.

The Microbacterium sp. X-18 is preserved in China Center for Type Culture Collection with a preservation date of Apr. 8, 2019 and a preservation number of CCTCC No: M 2019236 and a preservation address of Wuhan University, Wuhan, China.

A weight ratio of the microbial mixed bacteria, the organic fertilizer, and the soil is 1:1:8.

Further, the soil is slope protection soil collected nearby.

Further, the spraying thickness is 10 cm.

Further, a fermentation broth volume ratio of Kocuria sp. X-22, Microbacterium sp. X-26, Bacillus sp. X-28 and Microbacterium sp. X-18. is 1:1:1:1 in the microbial mixed bacteria.

Further, preparation methods of the fermentation broth are:
A. preparing strains of Kocuria sp. X-22, Microbacterium sp. X-26, Bacillus sp. X-28, and Microbacterium sp. X-18, and activating the prepared strains on a nutrient agar solid medium at 35° C. for 24 hours;
B. picking up a loop of bacterial paste of the activated Microbacterium sp. X-26, Bacillus sp. X-28 and Microbacterium sp. X-18 strains with an inoculation loop, adding the bacterial paste to a Luria-Bertani (LB) liquid medium respectively, inoculating Kocuria sp. X-22 into a Nutrient Agar (NA) liquid medium, and shaking the medium under a constant temperature of 35° C. with a frequency of 200 r/min for 24 hours to prepare a seed solution;
C. preparing the seed solution with 3% of the inoculum amount, inoculating the prepared seed solution into liquid medium, and culturing with shaking under a temperature of 35° C. with a frequency of 200 r/min for 36 hours to obtain the fermentation broth;
D. diluting the fermentation broth obtained in step C with sterile water and then mixing in an equal volume for use.

In step C, the liquid medium is 10 g peptone, 3 g yeast powder, 5 g sodium chloride, and 1000 mL sterile water, with a pH of 6.8-7.

Compared with the prior art, the present disclosure has the following technical advantages: the disclosure adopts the method of external-soil spray seeding to spray microbial mixed bacteria, organic fertilizer, and soil on the slope protection soil, and the green plant is Robinia pseudoacacia, so as to improve the pH value of the Robinia pseudoacacia soil. It can significantly increase the pH value of acidic soil, improve the content of soil organic matter, and reduce the number of chemical fertilizers. It is a green, environmentally friendly, economical and affordable microbial improvement method. It can provide a low-cost and efficient new method for the efficient and rapid green restoration of rock walls.

### BRIEF DESCRIPTION OF THE DRAWINGS

FIG. 1 is a diagram of the colonies of Kocuria sp. X-22, Microbacterium sp. X-26, Bacillus sp. X-28 and Microbacterium sp. X-18 on a nutrient agar solid medium; in the figure, A: Kocuria sp. X-22; B: Microbacterium sp. X-26; C: Bacillus sp. X-28; D: Microbacterium sp. X-18.

FIG. 2 is the application effect photo of the method of the present disclosure on exposed shale walls spraying; in the figure, A is before the special spraying greening construction; B is the special spraying greening construction site; C is 3 months after the special spraying greening construction; D is 5 years after the special spraying greening construction.

### DETAILED DESCRIPTION OF EMBODIMENTS

The present disclosure will be further described below in conjunction with specific embodiments.

Yueyang City is located on the south bank of the Yangtze River in northeastern Hunan, between 28° 25′33″˜29º51′00″ north latitude and 112º18′31″˜114º09′06″ east longitude, with a total area of 15019.2 square kilometers. Yueyang City is located in the East Asian monsoon climate zone. The climate zone is a transitional nature from the middle subtropics to the north subtropics, and it is a humid continental monsoon climate. The annual average rainfall is 1289.8˜1556.2 mm, and the rainfall in spring and summer accounts for 70%˜73% of the whole year. The annual average temperature is between 16.5˜17.2° C. During the growing season, light, heat and water are sufficient, and the agricultural climate conditions are good. Yueyang City has a developed water system, with 165 large and small lakes, and more than 280 large and small rivers directly flow into the Dongting Lake and the Yangtze River. The terrain of Yueyang City is high in the east and low in the west, leaning towards the Dongting Lake Basin in a step-like manner. The mountains account for 14.6%, hilly areas account for 41.2%, plains account for 27%, and water surfaces account for 17.2%. Due to road construction and other human activities on both sides of Yueyang Avenue, there are exposed rocks, mountain damage and serious soil erosion. In the following embodiments, exposed shale with a slope of 45° or more on both sides of Yueyang Avenue is used as a spraying green plot with a spraying thickness of 10 cm and a net.

### Embodiment 1

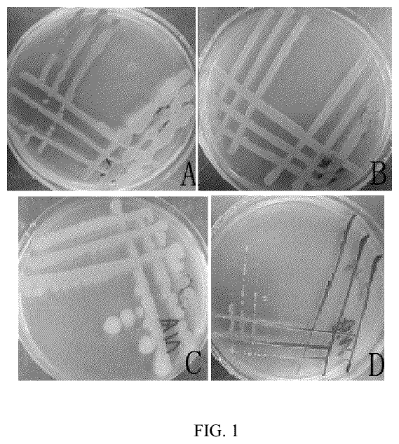

1) Acquisition and identification of strain
   Soil samples were collected from the 10 cm rhizosphere soil on the slopes on both sides of Yueyang Avenue in Yueyang City. The dilution coating plate method is adopted. In a 35° C. incubator, it was cultured on a nutrient agar solid medium (NA medium: peptone 10 g; beef powder 3 g; sodium chloride 5 g; agar 15 g; sterile water 1000 mL; pH 7) for 2 to 3 days. Different colonies were picked out by naked eye observation, and several different species of single colonies were obtained through repeated streaking and purification.
   A single colony was selected and made into a plate, and was sent to Shanghai Jinyu Medical Laboratory for sequencing, and the 16S rDNA gene sequence was obtained, as shown in SEQ ID NO.1. The detected 16S rDNA gene sequence was BLAST aligned with the sequence in the GenBank database. The results showed that the similarity between this strain and Kocuria polaris was 99.32%. The morphological characteristics (the center is yellow, and the edges are light yellow, moist and smooth, round, Gram staining is purple positive, and the shape is spherical) and 16S rDNA gene sequence were combined and analyzed, and it was identified as Kocuria sp. X-22.
   Another single colony was selected and made into a plate, and was sent to Shanghai Jinyu Medical Laboratory for sequencing, and the 16S rDNA gene sequence was obtained, as shown in SEQ ID NO.2. The detected 16S rDNA gene sequence was BLAST aligned with the sequence in the GenBank database. The results showed that the similarity between this strain and Microbacterium arabinogalactanolyticum was 98.91%. The morphological characteristics (dark yellow, moist and smooth, with a slightly bumpy round edge, Gram staining is purple, and the shape is short rod) and 16S rDNA gene sequence were combined and analyzed, and it was identified as Microbacterium sp. X-26.
   Still another single colony was selected and made into a plate, and was sent to Shanghai Jinyu Medical Laboratory for sequencing, and the 16S rDNA gene sequence was obtained, as shown in SEQ ID NO.3. The detected 16S rDNA gene sequence was BLAST aligned with the sequence in the GenBank database. The results showed that the similarity between this strain and Bacillus megaterium was 99.70%. The morphological characteristics (off-white, uneven surface, round, Gram stain is purple positive, the shape is short rod) and 16S rDNA gene sequence were combined and analyzed, and it was identified as Bacillus sp. X-28.
   Still another single colony was selected and made into a plate, and was sent to Shanghai Jinyu Medical Laboratory for sequencing, and the 16S rDNA gene sequence was obtained, as shown in SEQ ID NO.4. The detected 16S rDNA gene sequence was BLAST aligned with the sequence in the GenBank database. The results showed that the similarity between this strain and Microbacterium chocolatum was 99.75%. The morphological characteristics (it grows into thick-walled, smooth, tan colonies, and Gram-positive bacilli can be seen under a Gram staining microscope) and 16S rDNA gene sequence were combined and analyzed, and it was identified as Microbacterium sp. X-18.
2) The physiological and biochemical results of Kocuria sp. X-22, Microbacterium sp. X-26, Bacillus sp. X-28 and Microbacterium sp. X-18 are shown in Table 1, and the colony diagram is shown in FIG. 1.

TABLE 1
Physiological and biochemical results of strains

| | X-22 | X-26 | X-28 | X-18 |
|---|---|---|---|---|
| Glucose fermentation | +No bubbles | +No bubbles | +No bubbles | −No bubbles |
| Lactose fermentation | +No bubbles | −No bubbles | +No bubbles | −No bubbles |
| Starch hydrolysis | No circle | No circle | No circle | No circle |
| Indole test | − | − | + | − |
| Methyl red (MR) test | + | + | + | − |
| V.P. test | − | − | − | − |
| Citrate test | + | − | − | − |
| Hydrogen sulfide test | − | − | − | − |
| Gram stain | + | + | + | + |
| Colony morphology | coccus | bacillus | bacillus | short rod |

### Embodiment 2

1. Preparation of Microbial Mixed Bacteria
1) Strains of Kocuria sp. X-22, Microbacterium sp. X-26, Bacillus sp. X-28 and Microbacterium sp. X-18 were prepared, and the prepared strains were activated on a nutrient agar solid medium at 35ºC for 24 hours;
2) A loop of bacterial paste of the activated Microbacterium sp. X-26, Bacillus sp. X-28 and Microbacterium sp. X-18 strains was picked up with an inoculation loop and added to the LB liquid medium respectively, and Kocuria sp. X-22 was inoculated into NA liquid medium. The mediums were shaken at a constant temperature of 35° C., at a frequency of 200 r/min, for 24 hours to prepare a seed solution; the pH value of the seed liquid changes as shown in Table 2;

TABLE 2
Results of pH change of seed liquid before and after cultivation

| | Before | After | Medium |
|---|---|---|---|
| Microbacterium | 6.8-7.0 | 4.78 | LB |
| sp. X-18 | | | |
| Kocuria sp. X-22 | 6.8-7.0 | 8.35 | NA |
| Microbacterium | 6.8-7.0 | 8.77 | LB |
| sp. X-26 | | | |
| Bacillus sp. X-28 | 6.8-7.0 | 8.39 | LB |

3) The seed solution was taken with 3% of the inoculum amount and was inoculated into liquid medium (10 g peptone, 3 g yeast powder, 5 g sodium chloride, and 1000 mL sterile water, pH 5.56). The seed solution was cultured with shaking at a temperature of 35° ° C., at a frequency of 200 r/min, until the OD560 was 0.8-1.2 hours (about for 24-36 hours) to obtain the fermentation broth;
4) the fermentation broth obtained in step 3) was diluted with sterile water by 100 times, and then mixed in an equal volume for use.

2. Outdoor Spraying Experiment

Due to road construction and other human activities on both sides of Yueyang Avenue, there are exposed rocks, mountain damage and serious soil erosion. In this embodiment, external-soil spray seeding is used. The microbial mixed bacteria (mixed fermentation broth) are added to the organic fertilizer (Nanjing Zebra Experimental Equipment Co., Ltd.) and the soil. The weight ratio of the microbial mixed bacteria, the organic fertilizer, and the soil is 1:1:8. It is sprayed on the slope protection soil, the thickness of spraying is 10 cm, the net is hung, and the green plant is Robinia pseudoacacia. At the same time, three control groups are set up. Control group 1: the method is the same as the experimental group, and the plant is grassland, without adding microbial mixed bacteria. Control group 2: the method is the same as the experimental group, and the plant is Pinus massoniana. Control group 3: the method is the same as the experiment group, without adding microbial mixed bacteria. The physical and chemical properties of the rhizosphere soil of different green plants were tested. The pH value of the soil is measured with a mettler toledo pH meter (the ratio of water and soil is 5:1), and the soil organic matter is measured with the potassium dichromate bulk density method. The results are shown in Table 3.

TABLE 3
Rhizosphere soil organic matter content and pH value of different green plants

| | | | Total | |
|---|---|---|---|---|
| | organic matter | | phosphorus | Available phosphorus |
| | (g/kg) | pH | (g/kg) | (mg/kg) |
| Robinia | 70.901 ± 0.552a | 6.23 ± 0.2a | 0.136 ± 0.012a | 8.531 ± 0.317a |
| pseudoacacia | | | | |
| Pinus | 29.973 ± 1.26c | 5.91 ± 0.13b | 0.075 ± 0.006d | 0.827 ± 0.229c |
| massoniana | | | | |
| grassland | 22.425 ± 1.036d | 4.97 ± 0.32c | 0.094 ± 0.012c | 0.327 ± 0.085d |

Note:
The data in the table are the average ± standard deviation, and different lowercase letters indicate significant differences between different forest stands (P < 0.05).

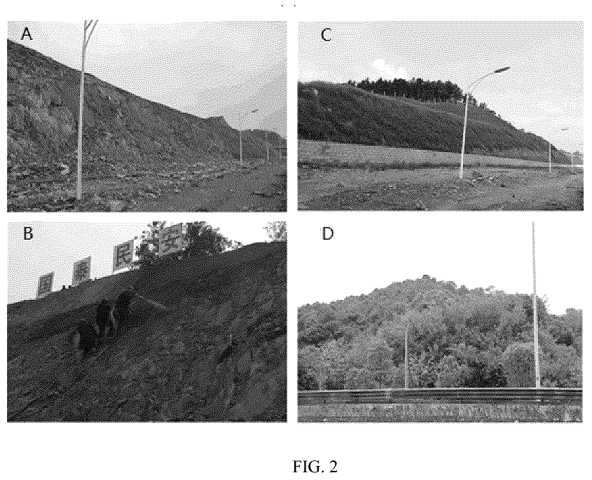

1) Soil pH
   Acidity and alkalinity of soil is an important index for evaluating soil nutrients. It has an extremely important impact on the growth and development of animals and plants, the distribution of microbial population characteristics and their activities, and the existence of soil nutrients. Comparative analysis found that the soil pH is between 4.97-6.4, which is acidic soil. For most plants, the most suitable pH range is weakly acidic to weakly alkaline. The soil pH of Robinia pseudoacacia tends to be neutral and is more suitable for plant growth. Compared with the Pinus massoniana control group, the soil pH of Robinia pseudoacacia was higher than that of Pinus massoniana, because it is a leguminous plant. The mixed bacteria can promote the nodulation and nitrogen fixation of Robinia pseudoacacia, produce a synergistic effect, and increase the pH of acidic soil. Compared with the control group of grassland without spraying inoculant, the pH of the rhizosphere soil of Robinia pseudoacacia increased by about 1.4 in five years, the difference was significant.
2) Organic matter
   Soil organic matter is an important part of the soil and the energy basis for soil microorganisms to survive. It can provide nutrients for vegetation growth, and affect the formation of soil structure, the availability of soil nutrients, and the complexity of soil biodiversity. The soil organic matter content was between 22.425-70.901 g/kg. Compared with the second soil survey in China, the average content of organic matter in the rhizosphere soil of Robinia pseudoacacia reached the first level (high level), the average content of organic matter in the rhizosphere soil of Pinus massoniana and Robinia pseudoacacia reached the third level (medium level). Among them, the organic matter content in the Robinia pseudoacacia soil was much higher than that in the blank control group and the Pinus massoniana soil, about 3 times that of the blank control group and the Pinus massoniana, and there was a significant difference (P<0.05).
3) Total phosphorus and available phosphorus content of soil
   The soil south of the Yangtze River in China has a strong leaching effect due to abundant rainfall, and is generally acidic, with very low available phosphorus content. Table 3 shows that the total phosphorus content of Robinia pseudoacacia and Pinus massoniana, grassland soil was significantly different (P<0.05). The total phosphorus content of the three forests: Robinia pseudoacacia>grassland>Pinus massoniana. The available phosphorus content was significantly different among the three forest soils (P<0.05); the available phosphorus content of the three forests: Robinia pseudoacacia>Pinus massoniana>grassland. The medium available phosphorus of Robinia pseudoacacia forest soil was the highest, and the content (8.531±0.317 mg/kg) was 10.3 times that of Pinus massoniana forest soil (0.827±0.229 mg/kg) and 26.1 times of grassland soil (0.327±0.085 mg/kg).
   As shown in FIG. 2, A and B are the construction site of the exposed shale rock walls, C is three months after construction, and D is five years after construction. Compared with the same group of rock spraying Robinia pseudoacacia (control group 3), with the addition of this group of mixed inoculants, the height of the Robinia pseudoacacia trees in 5 years was 7 meters, the average diameter at breast height was 7.8 cm, and the density was 200 plants/mu. In control group 3 without microbial mixed bacteria, the density of Robinia pseudoacacia was 3 plants/mu, the average tree height was 3 meters, and the diameter at breast height was 3 cm. The biomass per unit area was more than 100 times that of the control experiment.

1. A method for spraying Robinia pseudoacacia on exposed shale walls to efficiently and rapidly restore green and improve soil pH value, comprising:
spraying a microbial mixed bacteria, an organic fertilizer, and a soil on a slope protection soil of the exposed shale walls in an external-soil spray seeding manner with a spraying thickness of 8-10 cm and a green plant of Robinia pseudoacacia;
wherein the microbial mixed bacteria and the leguminous nitrogen-fixing bacteria are used synergistically to promote a rapid growth of Robinia pseudoacacia on the exposed shale walls and a rooting in crevices of the exposed shale walls; the exposed rock walls are quickly re-greened and the soil pH is improved; the leguminous nitrogen-fixing bacteria come from Robinia pseudoacacia; the microbial mixed bacteria comprises Kocuria sp. X-22, Microbacterium sp. X-26, Bacillus sp. X-28 and Microbacterium sp. X-18; the Kocuria sp. X-22 is preserved in China Center for Type Culture Collection with a preservation date of Apr. 8, 2019, a preservation number of CCTCC No: M 2019237 and a preservation address of Wuhan University, Wuhan, China;
the Microbacterium sp. X-26 is preserved in China Center for Type Culture Collection with a preservation date of Apr. 8, 2019, a preservation number of CCTCC No: M 2019238 and a preservation address of Wuhan University, Wuhan, China;
the Bacillus sp. X-28 is preserved in China Center for Type Culture Collection with a preservation date of Apr. 8, 2019, a preservation number of CCTCC No: M 2019239 and a preservation address of Wuhan University, Wuhan, China; and
the Microbacterium sp. X-18 is preserved in China Center for Type Culture Collection with a preservation date of Apr. 8, 2019, a preservation number of CCTCC No: M 2019236 and a preservation address of Wuhan University, Wuhan, China.

2-3. (canceled)

4. The method of claim 1, wherein a weight ratio of the microbial mixed bacteria, the organic fertilizer, and the soil is 1:1:8.

5. The method of claim 4, wherein the soil is nearby collected slope protection soil.

6. The method of claim 1, wherein the spraying thickness is 10 cm.

7. The method of claim 1, wherein a fermentation broth volume ratio of Kocuria sp. X-22, Microbacterium sp. X-26, Bacillus sp. X-28 and Microbacterium sp. X-18, is 1:1:1:1 in the microbial mixed bacteria.

8. The method of claim 7, wherein preparation methods of the fermentation broth are:
A. preparing strains of Kocuria sp. X-22, Microbacterium sp. X-26, Bacillus sp. X-28, and Microbacterium sp. X-18, and activating the prepared strains on a nutrient agar solid medium at 35° C. for 24 hours;
B. picking up a loop of bacterial paste of the activated Microbacterium sp. X-26, Bacillus sp. X-28 and Microbacterium sp. X-18 strains with an inoculation loop, adding the bacterial paste to a Luria-Bertani (LB) liquid medium respectively, inoculating Kocuria sp. X-22 into a Nutrient Agar (NA) liquid medium, and shaking the medium under a constant temperature of 35° ° C. with a frequency of 200 r/min for 24 hours to prepare a seed solution;
C. preparing the seed solution with 3% of the inoculum amount, inoculating the prepared seed solution into liquid medium, and culturing with shaking under a temperature of 35° C. with a frequency of 200 r/min for 36 hours to obtain the fermentation broth;
D. diluting the fermentation broth obtained in step C with sterile water and then mixing in an equal volume for use.

9. The method of claim 8, wherein the liquid medium in step C is 10 g peptone, 3 g yeast powder, 5 g sodium chloride, and 1000 mL sterile water, with a pH of 6.8-7.


SEQUENCE LISTING (4 sequences)

SEQ ID NO: 1 - DNA, 1082 bp, Artificial Sequence
  Kocuria sp.
cggaagtggcggcgtgcttacacatgcagtcgaacgatgatgcccagcttgctgggcggattagtggcgaacgggtgagtaatacgtgagtaacctgcccttgactctgggataagcctgggaaactgggtctaatactggatactacctcttaccgcatggtgggtggtggaaagggttttactggttttggatgggctcacggcctatcagcttgttggtggggtaatggctcaccaaggcgacgacgggtagccggcctgagagggtgaccggccacactgggactgagacacggcccagactcctacgggaggcagcagtggggaatattgcacaatgggcggaagcctgatgcagcgacgccgcgtgagggatgacggccttcgggttgtaaacctctttcagtagggaagaagcgagagtgacggtacctgcagaagaagcgccggctaactacgtgccagcagccgcggtaatacgtagggcgcaagcgttgtccggaattattgggcgtaaagagctcgtaggcggtttgtcgcgtctgctgtgaaagcccggggctcaaccccgggtctgcagtgggtacgggcagactagagtgcagtaggggagactggaattcctggtgtagcggtgaaatgcgcagatatcaggaggaacaccgatggcgaaggcaggtctctgggctgttactgacgctgaggagcgaaagcatggggagcgaacaggattagataccctggtagtccatgccgtaaacgttgggcactaggtgtgggggacattccacgttttccgcgccgtagctaacgcattaagtgccccgcctggggagtacggccgcaaggctaaaactcaaaggaattgacgggggcccgcacaagcggcggagcatgcggattaattcgatgcaacgcgaagaaccttaccaaggcttgacattcacggaccgccccagagatggggttcccttcgggctggtggacaggtggtgcatgatgtcgtcagctcgtgtcgtgaaaatgtggtaagtcccgcacgagcgcaaccctcgttctatgttgcagacacgtgatgtg

SEQ ID NO: 2 - DNA, 1093 bp, Artificial Sequence
  Microbacterium sp.
gggcgattgggcggcgtgcttacacatgcagtcgaacgatgaagcccagcttgctgggtggattagtggcgaacgggtgagtaacacgtgagcaacctgcccctgactctgggataagcgctggaaacggcgtctaatactggatatgtcccgtcaccgcatggtgtgcgggtggaaagatttttcggttggggatgggctcgcggcctatcagcttgttggtgaggtaatggctcaccaaggcgtcgacgggtagccggcctgagagggtgaccggccacactgggactgagacacggcccagactcctacgggaggcagcagtggggaatattgcacaatgggcggaagcctgatgcagcaacgccgcgtgagggatgacggccttcgggttgtaaacctcttttagcagggaagaagcgagagtgacggtacctgcagaaaaagcaccggctaactacgtgccagcagccgcggtaatacgtagggtgcaagcgttatccggaattattgggcgtaaagagctcgtaggcggtctgtcgcgtctgctgtgaaatcccgaggctcaacctcgggcttgcagtgggtacgggcagactagagtgcggtaggggagattggaattcctggtgtagcggtggaatgcgcagatatcaggaggaacaccgatggcgaaggcagatctctgggccgtaactgacgctgaggagcgaaagggtggggagcaaacaggcttagataccctggtagtccaccccgtaaacgttgggaactagttgtggggtcctttccacggattccgtgacgcagctaacgcattaagttccccgcctggggagtacggccgcaaggctaaaactcaaaggaattgacggggacccgcacaagcggcggagcatgcggattaattcgatgcaacgcgaagaccttaccaaggctgacttacacgagacgggccagaaatggtcactctttggacacctcgtgaacaggtggtgcatgctgtcgtcagctcgtgtctggaatgtgataagttcccgcacgagcgcaccctcgttctatgtggcagacacgtaattgtggaaacttcatg

SEQ ID NO: 3 - DNA, 1053 bp, Artificial Sequence
  Bacillus sp.
atggccgtggcggcgtgctatacatgcaagtcgagcgaactgattagaagcttgcttctatgacgttagcggcggacgggtgagtaacacgtgggcaacctgcctgtaagactgggataacttcgggaaaccgaagctaataccggataggatcttctccttcatgggagatgattgaaagatggtttcggctatcacttacagatgggcccgcggtgcattagctagttggtgaggtaacggctcaccaaggcaacgatgcatagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtacgagagtaactgctcgtaccttgacggtacctaaccagaaagccacggctaactacgtgccagcagccgcggtaatacgtaggtggcaagcgttatccggaattattgggcgtaaagcgcgcgcaggcggtttcttaagtctgatgtgaaagcccacggctcaaccgtggagggtcattggaaactggggaacttgagtgcagaagagaaaagcggaattccacgtgtagcggtgaaatgcgtagagatgtggaggaacaccagtggcgaaggcggctttttggtctgtaactgacgctgaggcgcgaaagcgtggggagcaaacaggattagataccctggtagtccacgccgtaaacgatgagtgctaagtgttagagggtttccgccctttagtgctgcagctaacgcattaagcactccgcctggggagtacggtcgcaagactgaaactcaaggattgacgggggcccgcacagcggtgagcatgtgtttaattcgaagcaacgcgaagaacttaccagtctgacatctctgacactctagagatagacgtcctctcgggacgagtgacaggtggtgcatgatgtcgtcagctcgtgtctgaaaatgtgggta

SEQ ID NO: 4 - DNA, 1040 bp, Artificial Sequence
  Microbacterium sp.
tagcaatggcggcgtgcttaccatgcagtcgaacggtgaaagagagcttgctctctggatcagtggcgaacgggtgagtaacacgtgagcaacctgccccggactctgggataacagctggaaacagctgctaataccggatacgagctgcgaaggcatcttcggcagctggaaagaatttcggtccgggatgggctcgcggcctatcagctagttggtgaggtaatggctcaccaaggcgtcgacgggtagccggcctgagagggtgaccggccacactgggactgagacacggcccagactcctacgggaggcagcagtggggaatattgcacaatgggcgaaagcctgatgcagcaacgccgcgtgagggatgacggccttcgggttgtaaacctcttttagcagggaagaagcgaaagtgacggtacctgcagaaaaagcgccggctaactacgtgccagcagccgcggtaatacgtagggcgcaagcgttatccggaattattgggcgtaaagagctcgtaggcggtttgtcgcgtctgctgtgaaaacccgaggctcaacctcgggcctgcagtgggtacgggcagactagagtgcggtaggggagattggaattcctggtgtagcggtggaatgcgcagatatcaggaggaacaccgatggcgaaggcagatctctgggccgtaactgacgctgaggagcgaaagggtggggagcaaacaggcttagataccctggtagtccaccccgtaaacgttggaactagttgtggggtccattccacggattccgtgacgcagctaacgcattaagttccccgcctggggagtacggccgcaggctaaactcaaggaattgacggggacccgcacagcggcggagcatgcggattaattcgatgcaacgcgaagaccttaccaaggcttgacatatacgagaccgggccagaatgtcaactctttggacacctcgtaacaggtgtgcatgttgtcgtcagctcgtgtcgtgagaatgttggttaagttcccgcaacga